(19) United States
(12) Patent Application Publication
(10) Pub. No.: US 2018/0372424 A1
(43) Pub. Date: Dec. 27, 2018

(54) VAPOR CHAMBER THAT EMITS A NON-UNIFORM RADIATIVE HEAT FLUX

(71) Applicant: MICROSOFT TECHNOLOGY LICENSING, LLC, Redmond, WA (US)

(72) Inventors: Erin HURBI, San Francisco, CA (US); Michael NIKKHOO, Saratoga, CA (US)

(21) Appl. No.: 15/629,403

(22) Filed: Jun. 21, 2017

(51) Int. Cl. F28D 20/02

(52) U.S. Cl. CPC F28D 20/025; C09K 5/02

(57) ABSTRACT

A vapor chamber that emits a non-uniform radiative heat flux. The vapor chamber may have a convection cavity that contains a working fluid and outer surfaces that have two or more emissivity regions to dissipate heat from the working fluid at non-uniform levels of radiative heat flux. The non-uniform levels of radiative heat flux may result from exposure to emissivity decreasing surface treatments and/or emissivity increasing surface treatments. The vapor chamber may be utilized in thermal management systems to protect heat-sensitive components from thermal radiation that results from heat being dissipated from a heat source. For example, the vapor chamber may be oriented with respect to a heat-sensitive component so that thermal radiation is emitted at a higher radiative heat flux away from the heat-sensitive component than towards the heat-sensitive component.

### BACKGROUND

Thermal management is a key consideration in the design of compact electronic devices such as laptop computers, wearable technologies, or any other device in which spatial constraints lead to heat generating components being located in close proximity to heat-sensitive components. Such considerations challenge designers to balance the competing goals of both dissipating heat away from heat generating components while also preventing dissipated heat from adversely affecting heat-sensitive components.

Conventional vapor chambers are sometimes used to dissipate heat from heat generating components into heat dissipation regions within compact electronic devices. More specifically, a conventional vapor chamber converts a localized high heat flux absorbed from a heat generating component into a relatively lower heat flux that is uniformly dispersed throughout a heat dissipation region. In some compact electronic devices, heat-sensitive components are inadvertently irradiated by some conventional vapor chamber designs. Unfortunately, this leads to such heat-sensitive components operating outside of an optimal temperature range and/or to the added cost and weight of heat shield components to protect heat-sensitive components from conventional vapor chambers.

It is with respect to these and other considerations that the disclosure made herein is presented.

### SUMMARY

Technologies described herein provide a vapor chamber that emits a non-uniform radiative heat flux. Generally described, the techniques disclosed herein enable modulation of surface treatment(s) on outer surface(s) of a vapor chamber to control an emissivity and, ultimately, a radiative heat flux emitted from various predetermined emissivity regions. Unlike conventional vapor chambers which emit a uniform radiative heat flux from all exposed surfaces (e.g., regardless where heat-sensitive components are located), the techniques described herein enable heat to be dissipated away from heat generating components toward specific regions of a compact electronic device which are unfettered by heat-sensitive components. In particular, the techniques described herein enable individual surface regions of a vapor chamber that face towards, or away from, heat-sensitive components to be specifically configured to emit lower, or higher, levels of radiative flux, respectively. For example, an individual surface region may be configured to have a desired emissivity through exposure to mechanical surface abrasion (e.g., surface roughening or surface polishing), oxidation techniques, anodization techniques, applying emissivity affecting layers to the individual surface region (e.g., polymer coatings, paints, etc.), or any other surface treatment technique suitable for modulating surface emissivity.

In some configurations, a vapor chamber comprises one or more walls having inner surfaces defining a convection cavity that contains a working fluid. The working fluid absorbs heat that is emitted against a heat absorbing portion(s) of the vapor chamber and convectively transfers the heat uniformly throughout a heat dissipating portion(s) of the vapor chamber. For example, the working fluid may be a bi-phase fluid that evaporates from a liquid state into a gaseous state upon absorbing latent heat at the heat absorbing portion of the vapor chamber. The working fluid may then flow, in the gaseous state, through the convection cavity to the heat dissipating portion(s) of the vapor chamber before releasing the latent heat and re-condensing into the liquid state. Exemplary working fluids include, but are not limited to, water, refrigerant substances (e.g., R134), ammonia based liquids, or any other substance suitable for efficiently transferring heat through convection.

At the heat dissipating portion of the vapor chamber, the latent heat may be conductively transferred through the one or more walls and, ultimately, dissipated through various heat transfer mechanisms from outer surfaces of the vapor chamber into an ambient environment. In particular, a portion of the latent heat may be convectively dissipated into the ambient environment as a medium (e.g., air) absorbs some of the latent heat and then flows away from the outer surfaces. Another portion of the latent heat may be irradiated from the outer surfaces through the medium in the form of thermal radiation.

The outer surfaces may further include two or more predetermined emissivity regions that are configured to dissipate at least some of the latent heat through thermal radiation at non-uniform levels of radiative heat flux. For illustrative purposes, suppose that the outer surfaces include a first emissivity region that has a first emissivity and a second emissivity region that has a second emissivity. Further suppose that the first emissivity is less than the second emissivity. Under these circumstances, if the outer surfaces of the vapor chamber are substantially the same temperature at both of the first emissivity region and the second emissivity region, the radiative heat flux emitted from the first emissivity region will be less than that emitted from the second emissivity region. It can be appreciated that modulating the surface treatment(s) to control an emissivity at various regions may in some instances have an effect on an amount of the latent heat that is convectively dissipated at the various regions whereas in other instances the surface treatment(s) may have no such effect.

In some configurations, the non-uniform levels of radiative heat flux may result from one or more predetermined emissivity regions being exposed to an emissivity decreasing surface treatment that reduces an emissivity of the one or more predetermined emissivity regions. In particular, the emissivity decreasing surface treatment may reduce an ability of the vapor chamber to emit infrared energy from specific regions of the outer surfaces. Exemplary emissivity decreasing surface treatments include, but are not limited to, polishing a specific emissivity region, electroplating the specific emissivity region, and/or applying a low emissivity layer to the specific emissivity region. As used herein, a “low emissivity layer” refers generally to any layer (e.g., of a solid material, a paint, a clear coating, or any other suitable product) that decreases an emissivity of a region to which the layer is applied.

In some configurations, the non-uniform levels of radiative heat flux may result from one or more predetermined emissivity regions being exposed to an emissivity increasing surface treatment that increases the emissivity of the one or more predetermined emissivity regions. In particular, the emissivity increasing surface treatment may increase the ability of the vapor chamber to emit infrared energy from specific regions of the outer surfaces. Exemplary emissivity increasing surface treatments include, but are not limited to, oxidizing a specific emissivity region, anodizing a specific emissivity region, and/or applying a high emissivity layer to the specific emissivity region. As used herein, a “high emissivity layer” refers generally to any layer (e.g., of a solid material, a paint, a clear coating, or any other suitable product) that increases an emissivity of a region to which the layer is applied.

These and various other features will be apparent from a reading of the following Detailed Description and a review of the associated drawings. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with another number included within a parenthetical (and/or a letter without a parenthetical) to refer to each individual item. Generic references to the items may use the specific reference number without the sequence of letters.

FIG. 1A is a perspective cross-section view of an exemplary vapor chamber that is configured to emit a non-uniform radiative heat flux.

FIG. 1B is a side cross-section view of the exemplary vapor chamber of FIG. 1A.

FIG. 2 is a perspective view of a thermal management system that includes a vapor chamber that is configured with a heat shield to protect one or more heat-sensitive components from thermal radiation.

FIG. 3 is a perspective view of a thermal management system that includes a vapor chamber comprising a segment that is configured to function as a heat shield with respect to a heat-sensitive component.

FIG. 4A illustrates a thermal management system that includes a vapor chamber having a first emissivity region that is positioned with respect to a second emissivity region to prevent thermal radiation emitted from the second emissivity region from propagating any predetermined direction.

FIG. 4B illustrates the thermal management system of FIG. 4A at least partially enclosed within a system housing having an at least partially transparent window through which at least some radiative heat exits the thermal management system.

FIG. 5 is a flow diagram of a process 500 for manufacturing a thermal management system.

### DETAILED DESCRIPTION

The following Detailed Description describes technologies for providing a vapor chamber that emits a non-uniform radiative heat flux to strategically dissipate heat with respect to heat-sensitive components of a compact electronic device. Generally described, the techniques disclosed herein enable modulation of surface treatment(s) on outer surface(s) of a vapor chamber to control a radiative heat flux emitted from various predetermined emissivity regions. The techniques described herein provide benefits over conventional vapor chambers for at least the reason that the disclosed techniques are not limited to dissipating heat into an ambient environment at a uniform radiative heat flux regardless of the vapor chamber's surroundings. Rather, by deploying the techniques described herein, one or more vapor chamber outer surfaces (and/or regions thereof) can be configured according to one or more predetermined surface treatments to modulate a radiative heat flux emitted towards (and/or away from) heat-sensitive components.

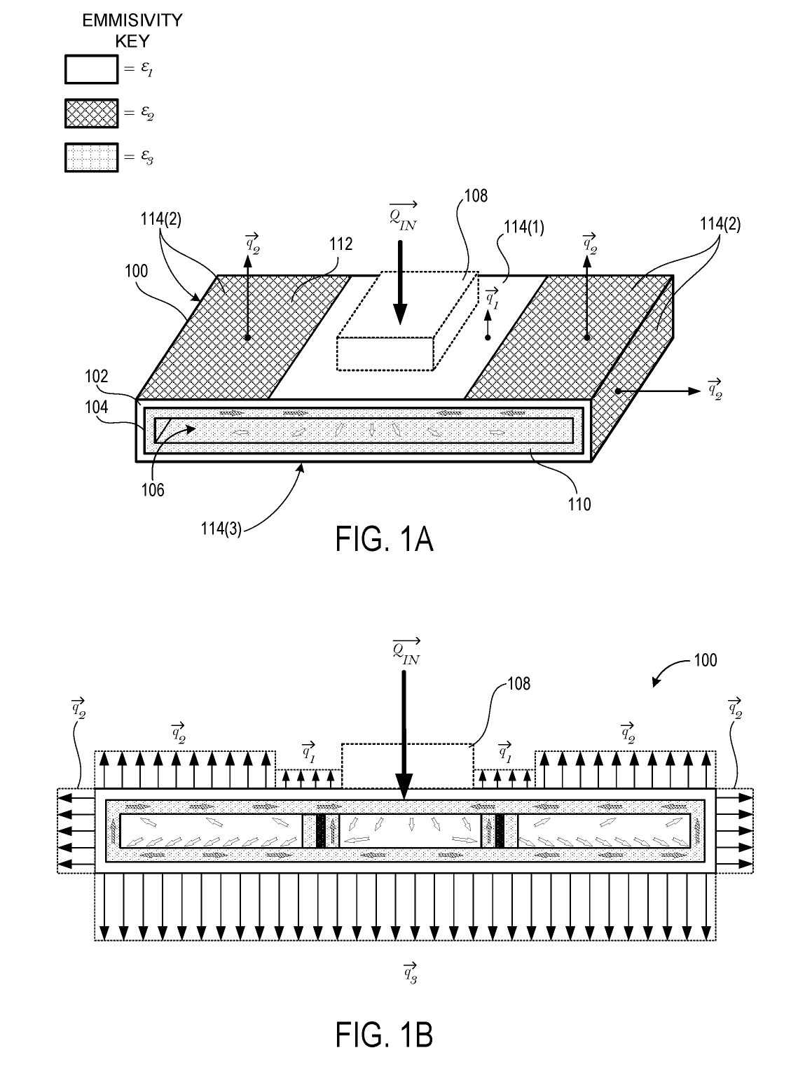

FIG. 1A is a perspective cross-section view of an exemplary vapor chamber 100 that is configured to emit a non-uniform radiative heat flux. FIG. 1B is a side cross-section view of the exemplary vapor chamber 100 of FIG. 1A. In this example, the vapor chamber 100 includes one or more walls 102 having inner surfaces 104 that defines a convection cavity 106 containing a working fluid. The working fluid absorbs heat that is emitted by a heat source 108 against the heat absorbing portion of the vapor chamber 100. The working fluid then convectively transfers the heat uniformly throughout a heat dissipating portion of the vapor chamber 100. Ultimately, the heat is dissipated from the vapor chamber 100 into an ambient environment.

In some embodiments, the working fluid is a bi-phase fluid that evaporates from a liquid state into a gaseous state upon absorbing latent heat that is transferred from the heat source 108 into the convection cavity 106. The working fluid may then flow in the gaseous state through the convection cavity 106 before releasing the latent heat had various portions of the inner surfaces 104. Upon releasing the latent heat and re-condensing into the liquid state, the working fluid flows back to the heat absorbing portion of the vapor chamber 100 where it absorbs additional heat emitted by the heat source 108 and, ultimately, re-evaporates back into the gaseous state and convectively transfers the additional heat uniformly throughout the heat dissipating portion of the vapor chamber 100. To further illustrate these concepts, FIGS. 1A & 1B include white arrows to represent flows of the working fluid in the gaseous state (e.g., an evaporated portion of the working fluid flowing away from a heat absorbing region that is adjacent to the heat source 108) and shaded arrows to represent flows of the working fluid in the liquid state (e.g., a condensed portion of the working fluid flowing back toward the heat absorbing region). Exemplary working fluids include, but are not limited to, water, refrigerant substances (e.g., R134), ammonia based liquids, or any other fluid suitable for efficiently transferring heat through convection.

In this example, the vapor chamber 100 further includes a wicking structure 110 to exert a capillary action on the condensed liquid and ultimately to assist in drawing the condensed liquid back to the heat absorbing portion of the vapor chamber 100. Exemplary wicking structures include, but are not limited to, sintered metal powders, screens, and/or grooved wicks that are sufficiently small to cause the working fluid to experience capillary forces within the grooved wicks at a boundary between the gaseous state and the liquid state.

The one or more walls 102 may further include outer surface(s) 112 that are configured to dissipate heat from the vapor chamber 100 in the form of thermal radiation at non-uniform levels of radiative heat flux. In particular, the outer surfaces 112 include a plurality of predetermined emissivity regions 114 that are configured to have two or more emissivity levels. In this example, the outer surfaces 112 include a first emissivity region 114(1) having a first emissivity (ε₁), a second emissivity region 114(2) having a second emissivity (ε₂), and a third emissivity region 114(3) having a third emissivity (ε₃). Furthermore, in this example the first emissivity (ε₁) is less than the second emissivity (ε₂), and the second emissivity (ε₂) is less than the third emissivity (ε₃). Accordingly, under circumstances in which the outer surfaces 112 of the vapor chamber 100 are substantially uniform in temperature, it can be appreciated that the vapor chamber 100 will emit thermal radiation at a non-uniform radiative heat flux. Stated alternatively, the radiative heat flux emitted from the outer surfaces 112 will vary across the predetermined emissivity regions 114.

For purposes of the present disclosure, individual ones of the predetermined emissivity regions 114 are patterned within the figures according to an “Emissivity Key” (shown in FIG. 1A) to indicate relative emissivity values, and therefore relative radiative heat fluxes, between the predetermined emissivity regions 114.

For purposes of the present discussion, the radiative heat flux \vec{q} (W/m²) (labeled with a lower-case letter “q”) is a thermal radiation component of a total heat flux \vec{Q}_{OUT} that is being dissipated from the vapor chamber 100. It can be appreciated that under most circumstances (e.g., where the temperature of an ambient environment and the outer surface 112 are not equal) the total heat flux \vec{Q}_{OUT} will also include a thermal convection component which in some examples may be substantially unaffected by the predetermined emissivity regions 114 having two or more emissivity levels. It can further be appreciated that under equilibrium conditions the total heat flux \vec{Q}_{OUT} that is dissipated by the vapor chamber 100 into the ambient environment will be equal to the total heat flux \vec{Q}_{IN} being absorbed by the vapor chamber 100 from the heat source 108.

With particular reference to FIG. 1B, in the present example the heat source 108 emits heat into the vapor chamber 100 at a heat flux \vec{Q}_{IN}. The heat is then absorbed by the working fluid within the convection cavity 106 at a heat absorbing portion (e.g., a portion of the convection cavity 106 adjacent to a location at which the heat source 108 is in thermal contact with the outer surfaces 112). The working fluid then convectively transfers the heat throughout the convection cavity 106 to enable the heat to be dissipated into the ambient environment. In this example, the working fluid is a bi-phase working fluid that includes a liquid portion that evaporates upon absorbing latent heat from the heat source 108 and re-condenses upon releasing the latent heat into the ambient environment. Accordingly, it can be appreciated that under normal operating conditions an internal temperature of the convection cavity 106 may be substantially uniform in temperature. It can further be appreciated that under circumstances where the thermal conductivity of the one or more walls 102 is sufficiently high, the temperature of the outer surface 112 may also be substantially uniform in temperature (e.g., ±1° F., ±3° F., ±5° F., etc.). Therefore, in various examples the relative levels of radiative heat flux \vec{q} (W/m²) emitted from the plurality of predetermined emissivity regions 114 will correspond to the relative emissivity levels of the predetermined emissivity regions 114.

In some embodiments, the vapor chamber 100 may be configured such that a lowest level of radiative heat flux is emitted from an emissivity region that may emit thermal radiation directly towards one or more heat-sensitive components. The one or more heat-sensitive components may include the heat source 108 and/or other components which may be adversely impacted by thermal radiation. In this example, the first emissivity (ε₁) at the first emissivity region 114(1) is lower than both of the second emissivity (ε₂) and the third emissivity (ε₃) at the second emissivity region 114(2) and the third emissivity region 114(3), respectively. Therefore, absent substantial variations in the temperature of the outer surfaces 112, the first emissivity region 114(1) will emit thermal radiation at a first radiative heat flux \vec{q}₁ that is lower than any other region of the vapor chamber 100. The relative length of the illustrated radiative heat flux vectors is representative of the relative magnitude of each corresponding radiative heat flux. In particular, in the illustrated example, the third radiative heat flux \vec{q}₃ is greater than the second radiative heat flux \vec{q}₂ which is greater than the first heat flux \vec{q}₁. Accordingly, in various implementations the vapor chamber 100 may be specifically designed to emit thermal radiation at a lowest rate from a particular emissivity region that faces toward one or more heat-sensitive components such as, for example, the heat source 108. Furthermore, in various implementations the vapor chamber 100 to be specifically designed to emit thermal radiation at a highest rate from a particular emissivity region that faces a way from one or more heat-sensitive components.

In some embodiments, the vapor chamber 100 may be configured such that a highest level of radiative heat flux is emitted from an emissivity region that is unable to emit thermal radiation directly towards one or more heat-sensitive components. In this example, the third emissivity (ε₃) at the third emissivity region 114(3) is higher than both of the second emissivity (ε₂) at the second emissivity region 114(2) and the first emissivity (ε₁) at the first emissivity region 114(1). Therefore, absent substantial variations in the temperature of the outer surfaces 112, the third emissivity region 114(3) will emit thermal radiation at a third radiative heat flux \vec{q}₃ that is higher than any other region of the vapor chamber 100.

In some embodiments, the non-uniform levels of radiative heat flux may result in non-uniform condensation rates of the working fluid within the convection cavity 106 and, more specifically, on the inner surfaces 104. For example, absent substantial temperature variations at the outer surfaces 112, it can be appreciated that a convective heat transfer rate may be substantially constant across all of the predetermined emissivity regions 114 despite the relative levels of radiative heat flux \vec{q} differing between the predetermined emissivity regions 114. Thus, the combined heat flux (e.g., the combined sum of a thermal radiation component and a thermal convection component) may differ between various ones of the predetermined emissivity regions 114 such that the latent heat may be released into the ambient environment at a lower combined heat flux at the first emissivity region 114(1) than at the second emissivity region 114(2). Therefore, because latent heat is released at a higher rate at the second emissivity region 114(2) than the first emissivity region 114(1), the rate at which the bi-phase fluid will condense from the gaseous state into the liquid state will be higher at the second emissivity region 114(2) than at the first emissivity region 114(1).

In some embodiments, the heat source 108 is in thermal contact with a particular side of the outer surfaces 112 that has a lower emissivity than one or more other sides of the outer surfaces 112. In the illustrated example, the heat source 108 is in physical contact (e.g., to facilitate conductive heat transfer) with a first side of the outer surfaces 112 on which the first emissivity region 114(1) is disposed. Furthermore, the third emissivity region 114(3) is disposed on a second side of the outer surfaces 112 that is opposite the first side. Accordingly, it can be appreciated that in some implementations the vapor chamber 100 may be configured to emit a higher level of radiative heat flux away from a heat-sensitive component (e.g., the heat source 108 from which the vapor chamber 100 is configured to dissipate the heat) than toward the heat-sensitive component.

The non-uniform levels of radiative heat flux may result from one or more of the emissivity regions 114 being exposed to an emissivity decreasing surface treatment. For example, the first emissivity region 114(1) may initially have (e.g., prior to the emissivity decreasing surface treatment) an initial emissivity that corresponds to a stock material from which the one or more walls 102 of the vapor chamber 100 are constructed. As a more specific but nonlimiting example, the one or more walls 102 may be constructed from rolled copper having an initial emissivity of ε_{rolled copper}=0.64. Then, subsequent to the vapor chamber 100 being constructed from the stock material (e.g., rolled copper), the first emissivity region 114(1) may be exposed to an emissivity decreasing surface treatment that decreases the initial emissivity to the first emissivity (ε₁) that results in the first radiative heat flux \vec{q}₁. Exemplary emissivity decreasing surface treatments include, but are not limited to, mechanical surface abrasion (e.g., polishing a specific emissivity region), electroplating the specific emissivity region, and/or applying a low emissivity layer to the specific emissivity region.

The non-uniform levels of radiative heat flux may result from one or more of the emissivity regions 114 being exposed to an emissivity increasing surface treatment. For example, the third emissivity region 114(3) may initially have the initial emissivity. Then, the third emissivity region 114(3) may be exposed to an emissivity increasing surface treatment that increases the initial emissivity to the third emissivity (ε₃) that results in the third radiative heat flux \vec{q}₃. Exemplary emissivity increasing surface treatments include, but are not limited to, mechanical surface abrasion (e.g., to bring a surface to a desired roughness), oxidizing a specific emissivity region (e.g., to modulate an oxidation layer type, thickness, and/or structure), anodizing a specific emissivity region, and/or applying a high emissivity layer (e.g., a polymer coating) to the specific emissivity region.

In some embodiments, one or more of the emissivity regions 114 may be left unexposed to any emissivity affecting surface treatments such that the initial emissivity is retained at these regions. For example, the second emissivity region 114(2) may be left untreated so that the initial emissivity that corresponds to the stock material from which the one or more walls 102 are constructed is retained at the second emissivity region 114(2).

In some embodiments, the non-uniform levels of radiative heat flux may result from at least one of the predetermined emissivity regions 114 being exposed to an emissivity increasing surface treatment and at least and another one of the predetermined emissivity regions 114 being exposed to an emissivity decreasing surface treatment. As a specific but nonlimiting example, the third emissivity (ε₃) may result from the third emissivity region 114(3) being oxidized whereas the first emissivity (ε₁) may result from the first emissivity region 114(1) being highly polished. It can be appreciated that exposing one or more of the predetermined emissivity regions 114 to an emissivity decreasing surface treatment and/or an emissivity increasing surface treatment may occur prior to or subsequent to the vapor chamber 100 being constructed from the stock material.

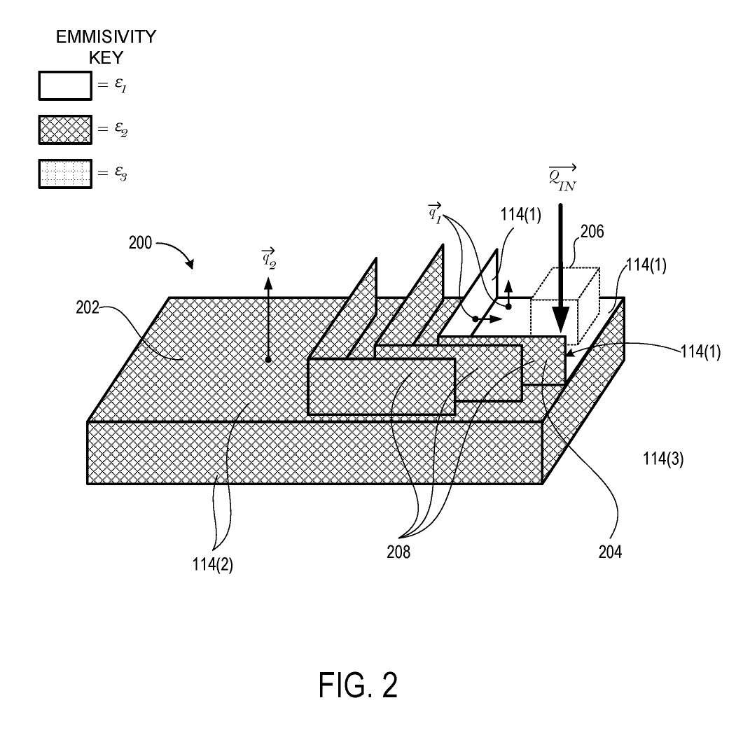

Turning now to FIG. 2, a perspective view is illustrated of a thermal management system 200 that includes a vapor chamber 202 that is configured with a heat shield 204 to protect a heat-sensitive component 206 from thermal radiation emitted from one or more of the predetermined emissivity regions 114. In this example, the vapor chamber 200 is configured to have a first emissivity region 114(1) having a first emissivity (ε₁) and a second emissivity region 114(2) having a second emissivity (ε₂) that is greater than the first emissivity (ε₁). In some implementations, the heat-sensitive component 206 may be a heat source that emits heat into the vapor chamber 202 at a heat flux \vec{Q}_{IN} and from which the vapor chamber 202 ultimately dissipates the heat into an ambient environment. In this example, the heat shield 204 is disposed between the heat-sensitive component 206 and the second emissivity region 114(2) to prevent a second radiative heat flux \vec{q}₂ from reaching one or more surfaces of the heat-sensitive component 206. With reference to the Emissivity Key of FIG. 2, it can be appreciated that the second emissivity region 114(2) includes each visible surface of the vapor chamber 202 and the heat shield 204 that is illustrated with a hatching pattern whereas the first emissivity region 114(1) includes only those surfaces of the vapor chamber 202 and the heat shield 204 having a direct path to one or more surfaces of the heat-sensitive component 206.

In some embodiments, the heat shield 204 may be further configured to function as a thermal dissipation structure. For example, the heat shield 204 may be a thermally conductive material (e.g., copper, aluminum, or any other material having a suitably high thermal conductivity) that is mechanically coupled to the vapor chamber 202 to enable at least some of the heat absorbed from a heat source to be conductively transferred into the heat shield 204. Ultimately, the heat transferred into the heat shield 204 may be convectively transferred out of the heat shield 204 to into an ambient environment and/or irradiated out of the heat shield 204 as thermal radiation. In some embodiments, the heat shield 204 may be an individual one of a plurality of fins 208. In some embodiments, the heat shield 204 may have different emissivity levels on different sides. For example, the heat shield 204 may have an emissivity on a side facing away from the heat-sensitive component(s) 206 that is relatively higher than another emissivity on another side of the heat shield 204 that faces the heat-sensitive component(s) 206.

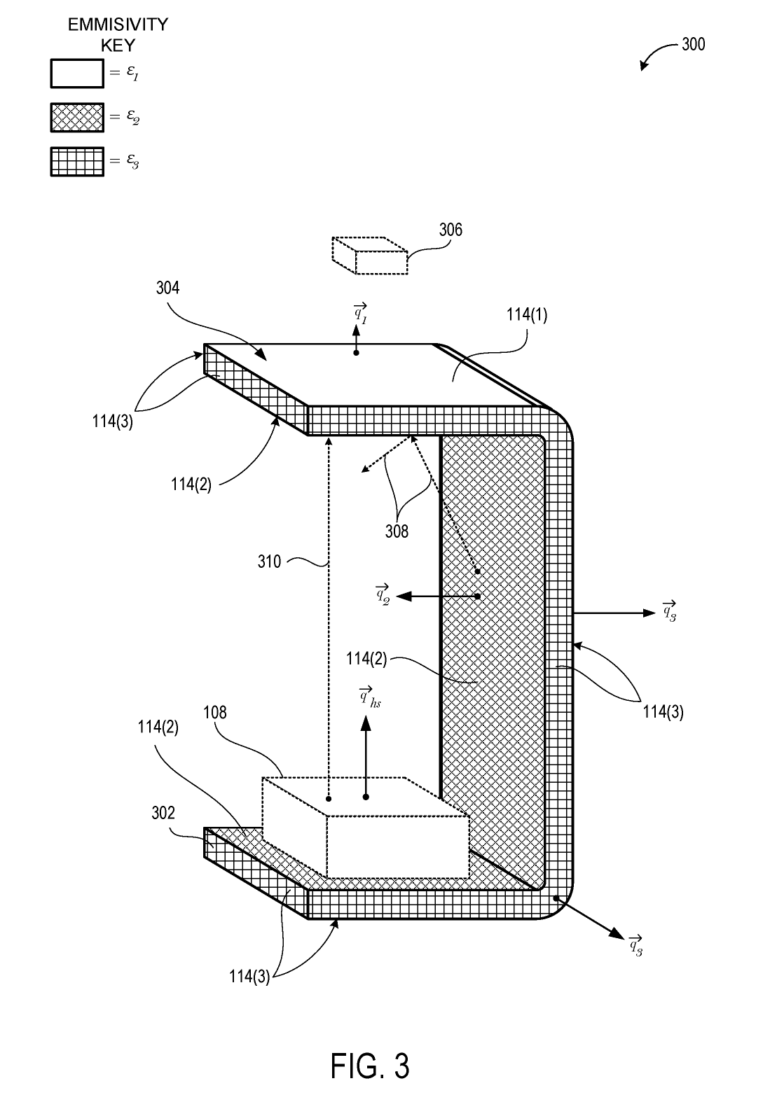

Turning now to FIG. 3, a perspective view is illustrated of a thermal management system 300 that includes a vapor chamber 302 comprising a segment 304 that is configured to function as a heat shield with respect to a heat-sensitive component 306. In this example, the vapor chamber 302 is configured to have a first emissivity region 114(1) having a first emissivity (ε₁) and a second emissivity region 114(2) having a second emissivity (ε₁). Furthermore, in this example the heat-sensitive component 306 is located with respect to the first emissivity region 114(1) and the second emissivity region 114(2) such that a first radiative heat flux \vec{q}₁ has an unobstructed path through which it can propagate and reach the heat-sensitive component 306 whereas the second radiative heat flux \vec{q}₂ cannot propagate directly to the heat-sensitive component 306. In particular, as shown by the exemplary thermal radiation path 308, thermal radiation that is emitted from the second emissivity region 114(2) toward the heat-sensitive component 306 will ultimately strike the segment 304 and be prevented from reaching the heat-sensitive component 306. In this way, it can be appreciated that the segment 304 can function to shield the heat-sensitive component from thermal radiation emitted from one or more of the predetermined emissivity regions 114.

In some embodiments, the vapor chamber 302 may be configured to emits thermal radiation from one or more surfaces that face towards the heat source 108 at a relatively lower radiative heat flux than from one or more other surfaces that face away from the heat source 108. In this example, the vapor chamber 302 includes a second emissivity region 114(2) having three discrete surfaces that each toward the heat source 108 and that are each individually labeled in FIG. 3. The vapor chamber 302 further includes a third emissivity region 114(3) having six discrete surfaces that each face away from the heat source 108. Accordingly, in an implementation where the second emissivity (ε₂) is lower than the third emissivity (ε₃), it can be appreciated that the third radiative heat flux \vec{q}₃ that is emitted away from the heat source 108 is greater than the second radiative heat flux \vec{q}₂ that is emitted towards the heat source 108.

In some embodiments, the segment 304 may be configured to shield the heat-sensitive component 306 from thermal radiation that is emitted from a heat source 108. In the illustrated example, the heat source 108 is shown to emit a radiative heat flux \vec{q}ₕₛ that depends on an emissivity of one or more outer surfaces of the heat source 108 as well as an external temperature of the one or more outer surfaces. As shown by the exemplary thermal radiation path 310, thermal radiation that is emitted from the heat source 108 toward the heat-sensitive component 306 will ultimately strike the segment 304 and be prevented from reaching the heat-sensitive component 306.

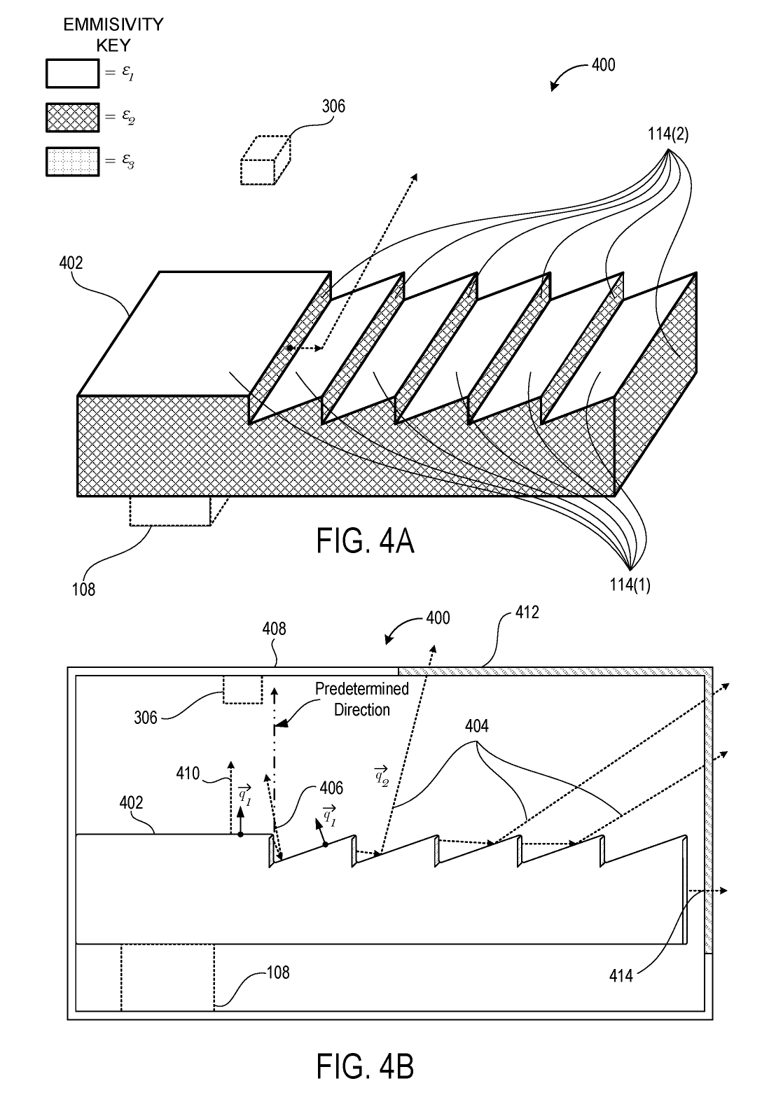

Turning now to FIGS. 4A and 4B (collectively referred to as FIG. 4), illustrated is a thermal management system 400 that includes a vapor chamber 402 having a first emissivity region 114(1) that is positioned with respect to a second emissivity region 114(2) to prevent thermal radiation emitted from the second emissivity region 114(2) from propagating in a predetermined direction. FIG. 4A is a perspective view of the thermal management system 400 and FIG. 4B is a side view of the thermal management system 400. In this example, the second emissivity region 114(2) is at least partially directed towards the first emissivity region 114(1) such that at least some of a second radiative heat flux \vec{q}₂ that is emitted from the second emissivity region 114(2) strikes the first emissivity region 114(1) at an angle of incidence that causes a portion of the second radiative heat flux \vec{q}₂ that reflects off of the first emissivity region 114(1) to propagate away from the predetermined direction. In this example, the predetermined direction is illustrated as being a vertical direction. The first emissivity region 114(1) is positioned with respect to the second emissivity region 114(2) to reflect the second radiative heat flux \vec{q}₂ along a plurality of thermal radiation paths 404 that propagate away from (e.g., do not cross a threshold of) the predetermined direction.

In some embodiments, the first emissivity region 114(1) is positioned with respect to the second emissivity region 114(2) such that a threshold percentage of the second radiative heat flux \vec{q}₂ that is reflected by the first emissivity region 114(1) propagates away from the heat-sensitive component 306. For example, as illustrated, at least one thermal radiation path 406 exists that permits a portion of the second radiative heat flux \vec{q}₂ to propagate towards the heat-sensitive component 306. Accordingly, it can be appreciated that it is within the scope of the present disclosure that a first emissivity region 114(1) is positioned with respect to a second emissivity region 114(2) such that at least fifty-percent of the second radiative heat flux \vec{q}₂ propagates away from the heat-sensitive component, at least seventy-percent of the second radiative heat flux \vec{q}₂ propagates away from the heat-sensitive component, at least ninety-percent of the second radiative heat flux \vec{q}₂ propagates away from the heat-sensitive component, or any other suitable threshold percentage of the second radiative heat flux \vec{q}₂.

In some embodiments, the thermal management system 400 may further include a system housing 408 that is configured to at least partially enclose one or more components of the thermal management system 400. In this example, the system housing is configured to at least partially enclose the heat source 108, the vapor chamber 402, and the heat-sensitive component 306. In various embodiments, the system housing 408 may include one or more mounting interfaces (not shown) at which one or more components of the thermal management system 400 may be coupled to the system housing 408.

In some embodiments, the heat-sensitive component 306 may be coupled to the system housing 408 at a location that is directly exposed to the first radiative heat flux \vec{q}₁ and is not directly exposed to the second radiative heat flux \vec{q}₂ (or at least a threshold amount thereof). In the illustrated example, it can be appreciated that the first radiative heat flux \vec{q}₁is able to irradiate from the first emissivity region 114(1) along a thermal radiation path 410 directly toward the heat-sensitive component 306 (e.g., without being reflected off any other surfaces). Stated alternatively, heat-sensitive component 306 is directly exposed to the first radiative heat flux \vec{q}₁. It can further be appreciated from the illustrated example that the second radiative heat flux \vec{q}₂ is not able to irradiate from the second emissivity region 114(2) directly toward the heat-sensitive component 306. Rather, only a small portion of the second radiative heat flux \vec{q}₂ is able to irradiate toward the heat-sensitive component 306 and this small portion is first reflected off of the first emissivity region 114(1) in accordance with the thermal radiation path 406. Stated alternatively, heat-sensitive component 306 is not directly exposed to the second radiative heat flux \vec{q}₂.

In some embodiments, the system housing 408 may comprise a translucent window 412 through which at least a portion of the second radiative heat flux \vec{q}₂ is able to irradiate to the exit the thermal management system 400. For example, as illustrated the thermal radiation paths 404 shows a three individual radiation paths through which thermal energy may be irradiated from the second emissivity region 114(1) through the translucent window 412. It can be appreciated that some radiation paths include the second radiative heat flux \vec{q}₂ being reflected off of one or more other surfaces such as, for example the first emissivity region 114(1) prior to exiting the thermal management system 400 via the translucent window 412. Other thermal radiation paths such as, for example thermal radiation path 414 enable at least some thermal energy to irradiate directly out of the thermal management system 400.

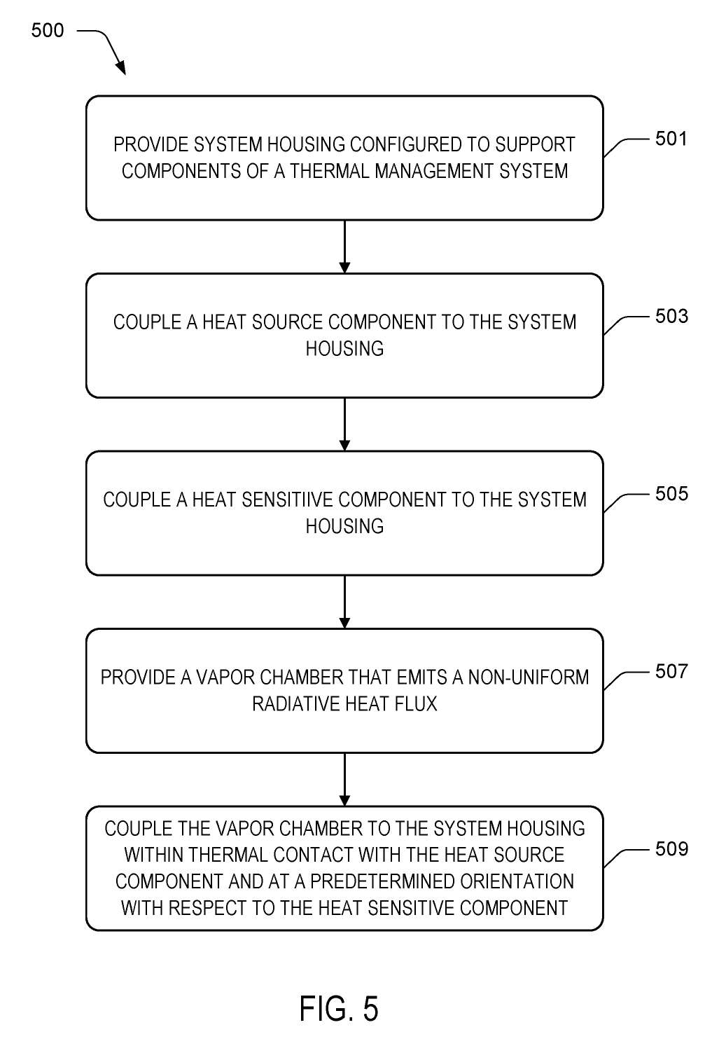

Turning now to FIG. 5, a flow diagram is illustrated of a process 500 for manufacturing a thermal management system. The process 500 is described with reference to FIGS. 1A-4B. The process 500 is illustrated as a collection of blocks in a logical flow. The order in which operations are described is not intended to be construed as a limitation, and any number of the described blocks can be combined in any order and/or in parallel to implement the process. Other processes described throughout this disclosure shall be interpreted accordingly.

Operation 501 includes providing a system housing that is configured to at least partially support a plurality of components of a thermal management system (e.g., the thermal management systems 300 and/or 400 as described herein). In some embodiments, the system housing may be a component of a compact electronic device such as, for example, a head-mounted display (HDM) device configured to implement virtual reality (VR) and/or augmented reality (AR) technologies, a laptop computing device, or any other type of compact electronic device. The system housing may include various mounts, fasteners, clips, holes, and/or any other type of coupling interface suitable for one or more components of the thermal management system to be coupled to.

Operation 503 includes coupling a first component of the thermal management system to the system housing wherein the first component functions as a heat source during operation. Exemplary heat sources include, but are not limited to, central processing units, graphics processing units, batteries, and/or any other component of a compact electronic device and/or thermal management system that may emit heat during operation.

Operation 505 includes coupling a second component of the thermal management system to the system housing wherein the second component is at least partially sensitive to thermal radiation (e.g., the heat-sensitive component 206 and/or 306). The second component may be any component of a thermal management system that is adversely affected by thermal radiation. For example, the second component may be an electronic component (e.g., a processing unit and/or a battery) that is adversely affected in terms of performance by thermal radiation. As a more specific, but non-limiting example, the may be a graphics processing unit having processing capabilities that are negatively impacted (e.g., in terms of processing speed and/or efficiency) at elevated temperatures.

Operation 507 includes providing a vapor chamber that emits a non-uniform radiative heat flux in accordance with the techniques described herein. For example, the vapor chamber may have an outer surface that includes at least a first emissivity region having a first emissivity and a second emissivity region having a second emissivity that is different (e.g., greater than and/or less than) the first emissivity. In some implementations, providing the vapor chamber at operation 507 may include exposing the second emissivity region to a predetermined surface treatment to increase an emissivity of the second emissivity region from an initial emissivity to the second emissivity. For example, operation 507 may include oxidizing the second emissivity region and/or exposing the second emissivity region to any other surface treatment that is suitable for increasing this region's emissivity. In some implementations, providing the vapor chamber at operation 507 may include exposing the first emissivity region to a predetermined surface treatment to decrease an emissivity of the first emissivity region from an initial emissivity to the first emissivity. For example, operation 507 may include polishing the first emissivity region and/or exposing the first emissivity region to any other surface treatment that is suitable for decreasing this region's emissivity.

Operation 509 includes coupling the vapor chamber to the system housing such that the vapor chamber is within thermal contact with the first component and is also at an orientation with respect to the second component that directs a first radiative heat flux from the first emissivity region toward the second component and directs a second radiative heat flux from the second emissivity region away from the second component. In some implementations, the second radiative heat flux is irradiated from one or more surfaces of the vapor chamber that face(s) away from the second component. For example, with particular reference to FIG. 3, it can be appreciated that the radiative heat flux emitted from the surfaces associated with the third emissivity region 114(3) and the radiative heat flux emitted from the particular surface of the second emissivity region 114(2) that is opposite the first emissivity region 114(1) each face away from the heat-sensitive 306.

In some implementations, operation 509 may include orienting the vapor chamber with respect to the system housing at a predetermined orientation that directs at least a portion of the second radiative heat flux through a translucent window of the system housing. For example, with particular reference to FIG. 4B, it can be appreciated that the vapor chamber 402 may be coupled to the system housing 408 at a predetermined orientation to dissipate radiative thermal energy from the thermal management system 400 via the thermal radiation paths 404 and 414.

### EXAMPLE CLAUSES

The disclosure presented herein may be considered in view of the following clauses.

Example Clause A, a vapor chamber for modulating radiative heat flux at a plurality of emissivity regions, the vapor chamber comprising: an outer surface that includes at least a first emissivity region and a second emissivity region, wherein at least one of the first emissivity region or the second emissivity region is configured according to a predetermined surface treatment to cause the outer surface to have a lower emissivity at the first emissivity region than at the second emissivity region; and an inner surface that defines a convection cavity that contains a working fluid for absorbing heat that is emitted by a heat source against at least a portion of the outer surface and transferring the heat, through the convection cavity, to the first emissivity region and the second emissivity region, wherein the working fluid dissipates the heat through the first emissivity region at a first radiative heat flux and through the second emissivity region at a second radiative heat flux, and wherein the lower emissivity causes the first radiative heat flux to be lower than the second radiative heat flux.

Example Clause B, the vapor chamber of Example Clause A, wherein the predetermined surface treatment includes at least one of polishing the first emissivity region, electroplating the first emissivity region, or applying a low emissivity layer to the first emissivity region.

Example Clause C, the vapor chamber of any one of Example Clauses A through B, wherein the predetermined surface treatment includes at least one of oxidizing the second emissivity region, anodizing the second emissivity region, or applying a high emissivity layer to the second emissivity region.

Example Clause D, the vapor chamber of any one of Example Clauses A through C, wherein the first emissivity region is on a first side of the outer surface and the second emissivity region is on a second side of the outer surface.

Example Clause E, the vapor chamber of Example Clause D, wherein the portion of the outer surface is configured to physically contact the heat source to conductively absorb the heat, and wherein the portion of the outer surface is on the first side that includes the first emissivity region.

Example Clause F, the vapor chamber of any one of Example Clauses A through E, wherein the second emissivity region is at least partially directed toward the first emissivity region to cause at least some of the second radiative heat flux to strike the first emissivity region at an angle of incidence that prevents the at least some of the second radiative heat flux from propagating in a predetermined direction.

Example Clause G, the vapor chamber of any one of Example Clauses A through F, wherein the working fluid functions as a bi-phase fluid that transfers the heat through the convection cavity as a gas, and wherein the lower emissivity causes the gas to re-condense into a liquid at a lower condensation rate at the first emissivity region than at the second emissivity region.

While Example Clauses A through G are described above with respect to a vapor chamber device, it is understood in the context of this document that the subject matter of Example Clauses A through G can also be implemented within a system and/or via a method of manufacturing.

Example Clause H, a thermal management system comprising: a vapor chamber having an inner surface that defines a convention cavity and an outer surface that includes at least a first emissivity region having a first emissivity and a second emissivity region having a second emissivity, wherein at least one of the first emissivity region or the second emissivity region is configured according to a predetermined surface treatment that causes the first emissivity to be lower than the second emissivity; a heat source that emits heat against at least a portion of the outer surface to cause a working fluid, that is contained within the convection cavity, to absorb the heat and to dissipate at least some of the heat as thermal radiation from the first emissivity region at a first radiative heat flux and from the second emissivity region at a second radiative heat flux that is higher than the first radiative heat flux; and a heat-sensitive component that is positioned with respect to at least one of the first emissivity region or the second emissivity region to modulate an amount of the thermal radiation that is incident to one or more surfaces of the heat-sensitive component.

Example Clause I, the thermal management system of Example Clause H, wherein the first emissivity region is configured according to the predetermined surface treatment to reduce an initial emissivity of the outer surface to the first emissivity, and wherein the second emissivity region is configured according to another predetermined surface treatment to increase the initial emissivity to the second emissivity.

Example Clause J, the thermal management system of any of Example Clauses H through I, wherein the heat source is disposed adjacent to the first emissivity region having the first emissivity that is lower than the second emissivity.

Example Clause K, the thermal management system of any of Example Clauses H through J, further comprising a system housing that is configured to at least partially enclose the heat-sensitive component and the vapor chamber, wherein the heat-sensitive component is coupled to the system housing at a location that is directly exposed to the first radiative heat flux and is not directly exposed to the second radiative heat flux.

Example Clause L, the thermal management system of any of Example Clauses H through K, further comprising a heat shield disposed between the heat-sensitive component and the second emissivity region to prevent the second radiative heat flux from reaching the one or more surfaces.

Example Clause M, the thermal management system of any of Example Clauses H through L, wherein the vapor chamber includes at least one bend that causes a segment of the vapor chamber to be disposed between the heat source and the heat-sensitive component to function as a heat shield.

Example Clause N, the thermal management system of Example Clause M, wherein the first emissivity region is disposed on a particular surface of the segment that faces the heat-sensitive component.

Example Clause O, the thermal management system of any of Example Clauses H through N, wherein the heat source that emits the heat is the heat-sensitive component, and wherein the heat source is positioned with respect to the first emissivity region to reduce the amount of the thermal radiation that is incident to the one or more surfaces.

While Example Clauses H through O are described above with respect to a thermal management system, it is understood in the context of this document that the subject matter of Example Clauses H through O can also be implemented within a vapor chamber device and/or via a method of manufacturing.

Example Clause P, method of manufacturing a thermal management system, the method comprising: providing a system housing that is configured to at least partially support a plurality of components of the thermal management system; coupling a first component that functions as a heat source to the system housing; coupling a second component that is at least partially sensitive to thermal radiation to the system housing; providing a vapor chamber having an outer surface that includes at least a first emissivity region having a first emissivity and a second emissivity region having a second emissivity that is greater than the first emissivity; and coupling, to the system housing, the vapor chamber within thermal contact with the first component and at an orientation that directs a first radiative heat flux from the first emissivity region toward the second component and a second radiative heat flux from the second emissivity region away from the second component.

Example Clause Q, the method of Example Clause P, further comprising exposing the second emissivity region to at least one predetermined surface treatment to increase an initial emissivity to the second emissivity.

Example Clause R, the method of any of Example Clauses P through Q, further comprising exposing the first emissivity region to at least one predetermined surface treatment to decrease an initial emissivity to the first emissivity.

Example Clause S, the method of any of Example Clauses P through R, wherein the first component is in physical contact with the vapor chamber to facilitate conductive heat transfer from the first component to the vapor chamber.

Example Clause T, the method of any of Example Clauses P through S, wherein the vapor chamber is coupled to the system housing at a predetermined orientation to direct at least a portion of the second radiative heat flux through at least one translucent window of the system housing.

While Example Clauses P through T are described above with respect to a method of manufacturing, it is understood in the context of this document that the subject matter of Example Clauses P through T can also be implemented within a vapor chamber device and/or via a thermal management system.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A vapor chamber for modulating radiative heat flux at a plurality of emissivity regions, the vapor chamber comprising:
an outer surface that includes at least a first emissivity region and a second emissivity region, wherein at least one of the first emissivity region or the second emissivity region is configured according to a predetermined surface treatment to cause the outer surface to have a lower emissivity at the first emissivity region than at the second emissivity region; and
an inner surface that defines a convection cavity that contains a working fluid for absorbing heat that is emitted by a heat source against at least a portion of the outer surface and transferring the heat, through the convection cavity, to the first emissivity region and the second emissivity region,
wherein the working fluid dissipates the heat through the first emissivity region at a first radiative heat flux and through the second emissivity region at a second radiative heat flux, and
wherein the lower emissivity causes the first radiative heat flux to be lower than the second radiative heat flux.

2. The vapor chamber of claim 1, wherein the predetermined surface treatment includes at least one of polishing the first emissivity region, electroplating the first emissivity region, or applying a low emissivity layer to the first emissivity region.

3. The vapor chamber of claim 1, wherein the predetermined surface treatment includes at least one of oxidizing the second emissivity region, anodizing the second emissivity region, or applying a high emissivity layer to the second emissivity region.

4. The vapor chamber of claim 1, wherein the first emissivity region is on a first side of the outer surface and the second emissivity region is on a second side of the outer surface.

5. The vapor chamber of claim 4, wherein the portion of the outer surface is configured to physically contact the heat source to conductively absorb the heat, and wherein the portion of the outer surface is on the first side that includes the first emissivity region.

6. The vapor chamber of claim 1, wherein the second emissivity region is at least partially directed toward the first emissivity region to cause at least some of the second radiative heat flux to strike the first emissivity region at an angle of incidence that prevents the at least some of the second radiative heat flux from propagating in a predetermined direction.

7. The vapor chamber of claim 1, wherein the working fluid functions as a bi-phase fluid that transfers the heat through the convection cavity as a gas, and wherein the lower emissivity causes the gas to re-condense into a liquid at a lower condensation rate at the first emissivity region than at the second emissivity region.

8. A thermal management system comprising:
a vapor chamber having an inner surface that defines a convention cavity and an outer surface that includes at least a first emissivity region having a first emissivity and a second emissivity region having a second emissivity, wherein at least one of the first emissivity region or the second emissivity region is configured according to a predetermined surface treatment that causes the first emissivity to be lower than the second emissivity;
a heat source that emits heat against at least a portion of the outer surface to cause a working fluid, that is contained within the convection cavity, to absorb the heat and to dissipate at least some of the heat as thermal radiation from the first emissivity region at a first radiative heat flux and from the second emissivity region at a second radiative heat flux that is higher than the first radiative heat flux; and
a heat-sensitive component that is positioned with respect to at least one of the first emissivity region or the second emissivity region to modulate an amount of the thermal radiation that is incident to one or more surfaces of the heat-sensitive component.

9. The thermal management system of claim 8, wherein the first emissivity region is configured according to the predetermined surface treatment to reduce an initial emissivity of the outer surface to the first emissivity, and wherein the second emissivity region is configured according to another predetermined surface treatment to increase the initial emissivity to the second emissivity.

10. The thermal management system of claim 8, wherein the heat source is disposed adjacent to the first emissivity region having the first emissivity that is lower than the second emissivity.

11. The thermal management system of claim 8, further comprising a system housing that is configured to at least partially enclose the heat-sensitive component and the vapor chamber, wherein the heat-sensitive component is coupled to the system housing at a location that is directly exposed to the first radiative heat flux and is not directly exposed to the second radiative heat flux.

12. The thermal management system of claim 8, further comprising a heat shield disposed between the heat-sensitive component and the second emissivity region to prevent the second radiative heat flux from reaching the one or more surfaces.

13. The thermal management system of claim 8, wherein the vapor chamber includes at least one bend that causes a segment of the vapor chamber to be disposed between the heat source and the heat-sensitive component to function as a heat shield

14. The thermal management system of claim 13, wherein the first emissivity region is disposed on a particular surface of the segment that faces the heat-sensitive component.

15. The thermal management system of claim 8, wherein the heat source that emits the heat is the heat-sensitive component, and wherein the heat source is positioned with respect to the first emissivity region to reduce the amount of the thermal radiation that is incident to the one or more surfaces.

16. A method of manufacturing a thermal management system, the method comprising:
providing a system housing that is configured to at least partially support a plurality of components of the thermal management system;
coupling a first component that functions as a heat source to the system housing;
coupling a second component that is at least partially sensitive to thermal radiation to the system housing;
providing a vapor chamber having an outer surface that includes at least a first emissivity region having a first emissivity and a second emissivity region having a second emissivity that is greater than the first emissivity; and
coupling, to the system housing, the vapor chamber within thermal contact with the first component and at an orientation that directs a first radiative heat flux from the first emissivity region toward the second component and a second radiative heat flux from the second emissivity region away from the second component.

17. The method of 16, further comprising exposing the second emissivity region to at least one predetermined surface treatment to increase an initial emissivity to the second emissivity.

18. The method of 16, further comprising exposing the first emissivity region to at least one predetermined surface treatment to decrease an initial emissivity to the first emissivity.

19. The method of 16, wherein the first component is in physical contact with the vapor chamber to facilitate conductive heat transfer from the first component to the vapor chamber.

20. The method of 16, wherein the vapor chamber is coupled to the system housing at a predetermined orientation to direct at least a portion of the second radiative heat flux through at least one translucent window of the system housing.
